(19) United States
(12) Patent Application Publication
(10) Pub. No.: US 2015/0273512 A1
(43) Pub. Date: Oct. 1, 2015

(54) APPARATUS AND METHOD FOR CLEANING

(71) Applicant: Anthony GAYDEN, Edgbaston, Birmingham West Midlands (GB)

(72) Inventor: Anthony Gayden, Edgbaston (GB)

(21) Appl. No.: 14/439,237

(22) PCT Filed: Oct. 31, 2013
(86) PCT No.: PCT/GB2013/052852

§ 371 Date: Apr. 29, 2015

(30) Foreign Application Priority Data
Oct. 31, 2012 (GB) 1219608.5
Nov. 19, 2012 (GB) 1220799.9
Dec. 6, 2012 (GB) 1222101.6

(51) Int. Cl. B05C 5/00; B08B 3/02

(52) U.S. Cl. CPC B05C 5/001; B08B 3/026

(57) ABSTRACT

Embodiments of the present invention provide cleaning apparatus (200) comprising: an applicator portion (201) having a fluid delivery outlet through which cleaning fluid heated in a boiler (210) may be dispensed; a boiler (210) through which a flow of cleaning fluid may be established from a fluid source (202) to the fluid delivery outlet of the applicator portion (201); and a heater portion (220), the boiler (210 comprising a heater conduit through which a flow of heated gases generated by the heater portion (220) may be established thereby to heat cleaning fluid in the boiler (210), the boiler (210 comprising a pair of hollow tubes being an inner tube arranged to pass through an outer tube, the boiler (210) being arranged wherein cleaning fluid to be heated may be heated in a reservoir provided between the tubes, the inner tube defining at least a portion of the heater conduit.

### FIELD OF THE INVENTION

The present invention relates to cleaning apparatus for cleaning and to a method of cleaning. In particular but not exclusively embodiments of the present invention relate to apparatus and a method of removing substances from a surface that are typically not easy to remove such as chewing gum, graffiti such as painted graffiti and the like. Some embodiments provide a portable cleaning apparatus.

### BACKGROUND

It is known to provide cleaning apparatus relying on a jet of heated cleaning fluid to soften and remove difficult substances such as chewing gum. The cleaning fluid may be water or contain one or more chemicals to enhance cleaning.

It is desirable to provide improved cleaning apparatus.

### STATEMENT OF THE INVENTION

Embodiments of the invention may be understood with reference to the appended claims.

Aspects of the present invention provide an apparatus and a method.

In one aspect of the invention for which protection is sought there is provided cleaning apparatus comprising:

an applicator portion having a fluid delivery outlet through which heated cleaning fluid may be dispensed;
a boiler through which a flow of cleaning fluid may be established from a fluid source to the fluid delivery outlet of the applicator portion; and
a heater portion, the heater portion being operable to heat the boiler thereby to heat the cleaning fluid,
wherein the apparatus comprises a heater conduit in thermal communication with the boiler through which a flow of heated gases generated by the heater portion may be established thereby to heat cleaning fluid in the boiler.

In one aspect of the invention for which protection is sought there is provided cleaning apparatus comprising:
an applicator portion having a fluid delivery outlet through which heated cleaning fluid may be dispensed;
a boiler through which a flow of cleaning fluid may be established from a fluid source to the fluid delivery outlet of the applicator portion; and
a heater portion, the heater portion being operable to heat the boiler thereby to heat the cleaning fluid, the boiler comprising a heater conduit through which a flow of heated gases generated by the heater portion may be established thereby to heat cleaning fluid in the boiler.

In an aspect of the invention for which protection is sought there is provided cleaning apparatus comprising:
an applicator portion having a fluid delivery outlet through which heated cleaning fluid may be dispensed;
a boiler through which a flow of cleaning fluid may be established from a fluid source to the fluid delivery outlet of the applicator portion; and
a heater portion,
the boiler comprising a heater conduit through which a flow of heated gases generated by the heater portion may be established thereby to heat cleaning fluid in the boiler, the boiler comprising a pair of hollow tubes being an inner tube arranged to pass through at least a portion of an outer tube, the boiler being arranged wherein cleaning fluid to be heated may be heated in a reservoir provided between the tubes, the inner tube defining at least a portion of the heater conduit.

It is to be understood that liquid in the reservoir may be in contact with and constrained by outer and inner walls of the inner and outer tubes, respectively. Thus the reservoir may substantially fill a volume defined by the inner and outer tubes respectively.

Embodiments of the invention have the advantage that cleaning fluid contained within the boiler may be heated in an efficient and relatively rapid manner to a temperature required for cleaning. Furthermore, heated gases generated by the heater portion may be vented from the apparatus in a controlled manner.

It is to be understood that in some embodiments the apparatus is configured such that the heater portion heats the boiler in an indirect manner. That is, the boiler is heated by hot gases generated by the heater portion such as combustion gases and/or gases heated by the heater portion, which in turn heat water in the boiler. Some embodiments are arranged such that the heater portion generates a flame. In some embodiments the flame is arranged not to contact the boiler, for example not to contact the heater conduit. This feature has the advantage that relatively large variations in temperature of the boiler such as portions of the heater conduit due for example to the establishment of local hot spots due to direct impingement by the flame, may be prevented.

Embodiments of the present invention may be useful in removing substances such as gum (for example chewing gum) that may be dried, aged or fresh, graffiti (wet, longstanding and aged) from soft and hard surfaces such as concrete, asphalt, pavement, carpet, plastics materials and many other surfaces. Some embodiments may also be useful in removing other unwanted substances such as paint such as paint in the form of road markings, for example when alternative signage is introduced. Embodiments of the present invention have the advantage that a flame is not required to be applied directly to the material to be removed such as paint, to burn away the paint. Furthermore, copious quantities of liquid such as water are not required to be applied, resulting in the generation of a slip hazard. Rather, relatively small amounts of cleaning fluid may be applied to the substance to be removed, optionally in combination with light mechanical agitation in order to remove it. As discussed in more detail below, the cleaning fluid may be or comprise water. The cleaning fluid may advantageously be applied to the substance to be removed in gaseous or vapour form, for example as steam. Other fluids are also useful.

Embodiments of the invention may be of considerable benefit to society since they permit removal of unsightly and nuisance substances. They may also be of considerable benefit to municipal organisations, contractors, facilities management companies, cleaning contractors as well as for personal domestic use.

The inner and outer tubes may have substantially parallel longitudinal axes. The axes may be substantially coincident, or spaced apart. The tubes may have any suitable cross-sectional shape such as substantially circular, rectangular, polygonal, triangular oblong, oblate or any other suitable shape. The tubes may be of different respective cross-sectional shapes.

The apparatus may be configured in use to generate a flow of gaseous cleaning fluid from the fluid delivery outlet. The flow of gaseous cleaning fluid may be arranged to pass out from the boiler at a pressure in a prescribed range of pressures or a flow rate in a prescribed range. Other arrangements are also useful.

Advantageously the heater conduit may be arranged to pass through (that is, be provided through) at least a portion of the boiler such that in use cleaning fluid in the boiler may surround at least a portion of the heater conduit, optionally substantially surround the heater conduit.

This feature has the advantage that a larger surface area of the conduit may be provided in thermal communication with cleaning fluid in the boiler, the thermal communication being through a wall of the conduit.

The heater conduit may comprise a substantially cylindrical pipe.

The boiler may be in the form of a hollow tube. The boiler may comprise a pair of concentric hollow tubes, arranged wherein cleaning fluid to be heated may be heated in a reservoir provided between the tubes. The inner tube may define at least a portion of the heater conduit. Thus, the boiler may be in the form of a double walled tube or pipe.

In an embodiment of the present invention for which protection is sought there is provided cleaning apparatus comprising:

an applicator portion having a fluid delivery outlet through which heated cleaning fluid may be dispensed;
a heater portion operable to generate heated gases;
a boiler in the form of a double walled pipe having an outer pipe through which a flow of cleaning fluid may be established from a fluid source to the fluid delivery outlet of the applicator portion and an inner pipe defining a heater conduit through which a flow of the heated gases generated by the heater portion may be established such that, in use, cleaning fluid flowing through the outer pipe may be heated by the heated gases flowing through the inner pipe.

As noted above, in some embodiments by arranging the heater portion to generate heated gases, the heater portion is able to indirectly, rather than directly, heat the cleaning fluid flowing through the boiler. This indirect heating feature may advantageously provide a safe and controlled heating effect.

The heater portion may be arranged to direct heated gases directly into the heater conduit.

The heater portion may be provided substantially coaxial of the heater conduit. The heater portion may be provided at a location axially spaced apart from the heater conduit. Alternatively, the heater portion may be provided immediately adjacent to or within at least a portion of the heater conduit.

The axis of the boiler and heater portion may be arranged to be substantially parallel to, optionally substantially coincident with, a longitudinal axis of the applicator portion.

The apparatus may be comprised substantially entirely by the applicator portion in some embodiments.

The heater conduit may advantageously be arranged to direct heated gases through an exhaust outlet of the apparatus.

Advantageously a blower may be provided for blowing gas through the heater conduit.

Optionally the blower is arranged to blow ambient air through the heater conduit.

In some embodiments this feature ensures that heated gases flow out from the apparatus through the exhaust outlet regardless of an orientation of the apparatus, or of expected in-use motion of the apparatus. Furthermore, this feature ensures that heated gases do not build up within the apparatus. Further advantageously, in some embodiments this feature may increase the proportion of heat generated by the heater portion that passes through the heater conduit. This can enhance user enjoyment of the apparatus by reducing heating of a wall of the apparatus. This may enhance ‘cool touch’ operation whereby an amount of heating of a casing of the apparatus by the heater portion is reduced.

The blower may be arranged to establish a flow of gas around the heater portion and through the heater conduit. This feature may further enhance operation of the apparatus by increasing the proportion of heat generated by the heater portion that flows through the heater conduit.

The gas is advantageously ambient air although other gases are also useful.

It is to be understood that where the heated gases are gases heated by a heater portion in the form of an electrical element, the gases may be heated air. In the case the heater portion is in the form a burner, the gases may comprise combustion gases and, in some embodiments, air in addition. The gas that is blown through the heater conduit may pass through or past the heater portion such and at least some of the gas burned by the heater portion upon mixing with a fuel. In the case where the gas is air, oxygen in the air may be burned with fuel supplied to the heater portion.

Advantageously the apparatus may comprise a reservoir for storing cleaning fluid before it is supplied to the boiler.

The heater portion may comprise a burner or an electrical heating element to generate heated gases. In the vase of an electrical element, the element may be arranged to heat liquid in the boiler by a combination of radiative heating of the boiler and flow of heated gases through the heater conduit. Flow of heated gases through the heater conduit may be assisted by blowing in some embodiments.

It is to be understood that where the heated gases are gases heated by a heater portion in the form of an electrical element, the gases may be heated air. In the case where the heater portion is in the form a burner, the gases may comprise combustion gases and, in some embodiments, air in addition, the air including unburned oxygen.

The apparatus may comprise a fuel storage reservoir for storing fuel for the burner. The fuel storage reservoir may be arranged to store pressurised gas and/or liquefied gas.

The burner may be arranged to burn gaseous fuel, optionally methane and/or ethane and/or propane and/or butane. Other gases are also useful such as liquefied petroleum gas (LPG). In some embodiments the burner may be arranged to burn liquid fuel such as kerosene or any other suitable liquid fuel.

Advantageously the applicator portion may comprise the boiler and the heater portion. This has the advantage that heating of the cleaning fluid may be arranged to take place relatively close to the fluid delivery outlet. This feature has the advantage that an amount of cooling of the cleaning fluid before it emerges from the delivery outlet and is applied to the substance to be removed may be reduced. The applicator portion may be in the form of a lance, a wand or any other suitable arrangement. Thus the applicator portion may be arranged to be hand held, and therefore portable. As described below, the entire apparatus may be arranged to be portable.

In some embodiments the applicator portion may comprise the reservoir for storing cleaning fluid and the fuel storage reservoir. The applicator portion may comprise the blower. The blower may be a fan of any suitable type including a rotary vane fan, a roots blower, a centrifugal blower or any other suitable blower.

One or more components of the apparatus may be provided remote from the applicator portion. For example the one or more components may be provided in a cart or other mobile unit that may be pulled or pushed along by an operator. Alternatively the one or more components may be provided in a package suitable for wearing by a user. In some embodiments the one or more components may be provided in a backpack or front pack. The pack may have one or more straps arranged to be worn over one or both shoulders of an operator. It has been found that use of a back-pack represents a particularly user-friendly solution to the problem of transporting the apparatus in use. The components of the apparatus stored in the backpack, which in some embodiments include fuel and cleaning fluid, may be made relatively lightweight. In the case of a front pack may rest on a chest of a user. In some embodiments the package may be attached to a belt, or be provided with a belt or in the form of a belt to be worn around a waist of a user.

In an embodiment the cleaning fluid reservoir and the fuel storage reservoir are provided in a backpack together with the blower. The blower may be arranged to blow air along an air conduit to the applicator portion, the air conduit being in fluid communication with the burner conduit.

In an embodiment the fuel storage reservoir is arranged to be heated by heat generated by the apparatus thereby to prevent the fuel storage reservoir from becoming excessively cooled by expansion of gas fed to the burner therefrom. In some embodiments the fuel storage reservoir is provided in thermal communication with the burner. In some embodiments, in addition or instead the fuel storage reservoir is provided in thermal communication with the boiler. In some embodiments the fuel storage reservoir is arranged to be heated by another source of heat such as an electrical component of the apparatus. In some embodiments the apparatus is provided with a valve device having a valve actuator such as a solenoid, the valve being arranged to control flow of fuel from the fuel storage reservoir when the apparatus is in use. The valve may be arranged to generate heat when the valve is in an open condition in which the valve allows a flow of fuel from the fuel storage reservoir, such as a flow of gas. The heat generated by the valve when in the open condition may be arranged to heat the fuel storage reservoir, an outlet of the fuel storage reservoir and/or a portion of a pipe carrying fuel from the fuel storage reservoir, so as to prevent over-cooling of a portion of the apparatus. Over cooling may cause freezing of fuel and/or water vapour in the fuel or ambient air and adversely affect or prevent correct operation of the apparatus.

The apparatus may be arranged wherein the burner is configured to direct a flame of burning or burnt fuel in a direction towards the delivery outlet with respect to the applicator portion. In some embodiments, in a normal upright orientation of the applicator portion in the form of a lance member, in which the lance member points downwardly when applying cleaning fluid to a floor surface from a free end of the lance member, the burner may be arranged to point downwardly, optionally in a direction substantially parallel to a longitudinal axis of the lance, towards the floor surface.

If the heater portion comprises an electrical heating element, the heating element may be powered by a battery. The battery may be stored in the applicator portion or in a separate portion of the apparatus such as a backpack module or other portion.

In one aspect of the invention for which protection is sought there is provided cleaning apparatus comprising:
an applicator portion having a fluid delivery outlet through which heated cleaning fluid may be dispensed;
a heater portion; and
a boiler comprising a heater conduit through which a flow of heated gases generated by the heater portion may be established thereby to heat cleaning fluid in the boiler, the boiler comprising a pair of hollow tubes, arranged wherein cleaning fluid to be heated may be heated in a reservoir provided between the tubes, the inner tube defining at least a portion of the heater conduit.

The boiler may be arranged to allow a flow of cleaning fluid to be established therethrough from a source of fluid to the fluid delivery outlet of the applicator portion.

In an aspect of the invention for which protection is sought there is provided a method of cleaning comprising:
providing cleaning apparatus having an applicator portion having a fluid delivery outlet through which heated cleaning fluid may be dispensed;
establishing a flow of cleaning fluid from a fluid source to the fluid delivery outlet of the applicator portion through a boiler; and
generating heated gases by means of a heater portion;
establishing a flow of the heated gases through a heater conduit of the boiler thereby to heat cleaning fluid in the boiler,
the method comprising establishing the flow of cleaning fluid through a reservoir provided between a pair of hollow tubes of the boiler wherein an inner tube of the pair passes through an outer tube of the pair, the inner tube defining at least a portion of the heater conduit.

In an aspect of the invention for which protection is sought there is provided a method comprising:
providing cleaning apparatus having an applicator portion having a fluid delivery outlet through which heated cleaning fluid may be dispensed;
establishing a flow of cleaning fluid from a fluid source to the fluid delivery outlet of the applicator portion through a boiler;
generating heated gases by means of a heater portion; and
establishing a flow of the heated gases through a heater conduit of the boiler thereby to heat cleaning fluid in the boiler,
the method comprising establishing the flow of cleaning fluid through a reservoir provided between a pair of hollow tubes of the boiler wherein an inner tube of the pair passes through an outer tube of the pair, the inner tube defining at least a portion of the heater conduit.

The method may comprise removal of a substance from a surface by applying heated cleaning fluid to the substance, optionally agitating the substance during and/or after applying heated cleaning fluid to the substance.

The method may comprise cleaning a surface by applying heated cleaning fluid to a surface or a substance on the surface.

The inner and outer tubes may be provided substantially concentric of one another.

The inner and outer tubes may be provided substantially coaxial of one another.

Within the scope of this application it is envisaged that the various aspects, embodiments, examples, features and alternatives set out in the preceding paragraphs, in the claims and/or in the following description and drawings may be taken independently or in any combination. Features described with reference to one embodiment are applicable to all embodiments, unless there is incompatibility of features.

For the avoidance of doubt, it is to be understood that features described with respect to one aspect of the invention may be included within any other aspect of the invention, alone or in appropriate combination with one or more other features.

### BRIEF DESCRIPTION OF THE DRAWINGS

Embodiments of the invention will now be described with reference to the accompanying figures in which:

FIG. 1 is a schematic illustration of a lance member of an apparatus according to an embodiment of the present invention;

FIG. 2 is a schematic illustration of a back-pack module for use with the lance member of FIG. 1;

FIG. 3 shows the lance member of FIG. 1 connected to the backpack module of FIG. 2;

FIG. 4 is a perspective view of the boiler of the embodiment of FIG. 1;

FIG. 5 shows a lance member according to a further embodiment of the invention;

FIG. 6 shows a lance member according to a further embodiment of the invention;

FIG. 7 shows a backpack module according to a further embodiment of the invention; and

FIG. 8 shows a lance member according to a further embodiment of the invention.

### DETAILED DESCRIPTION

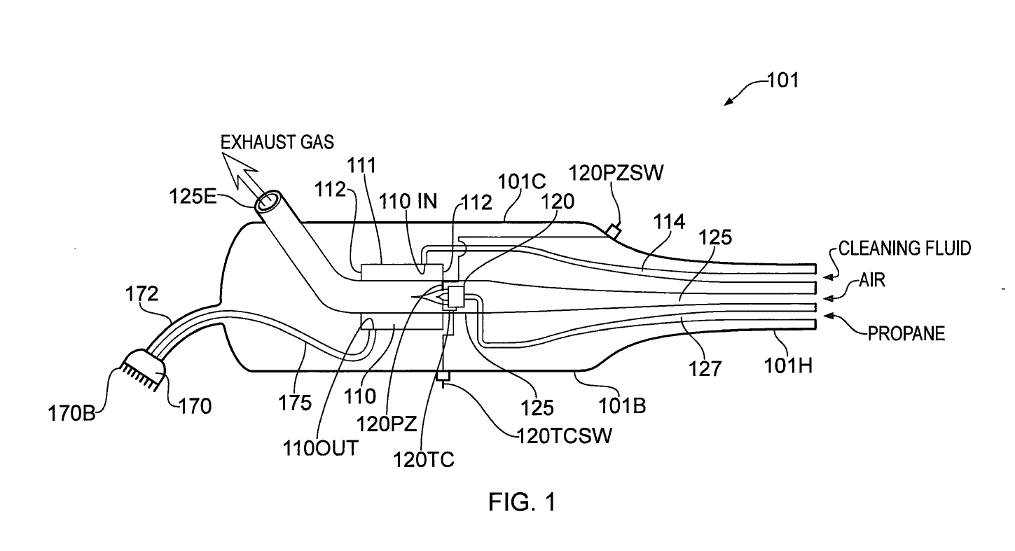

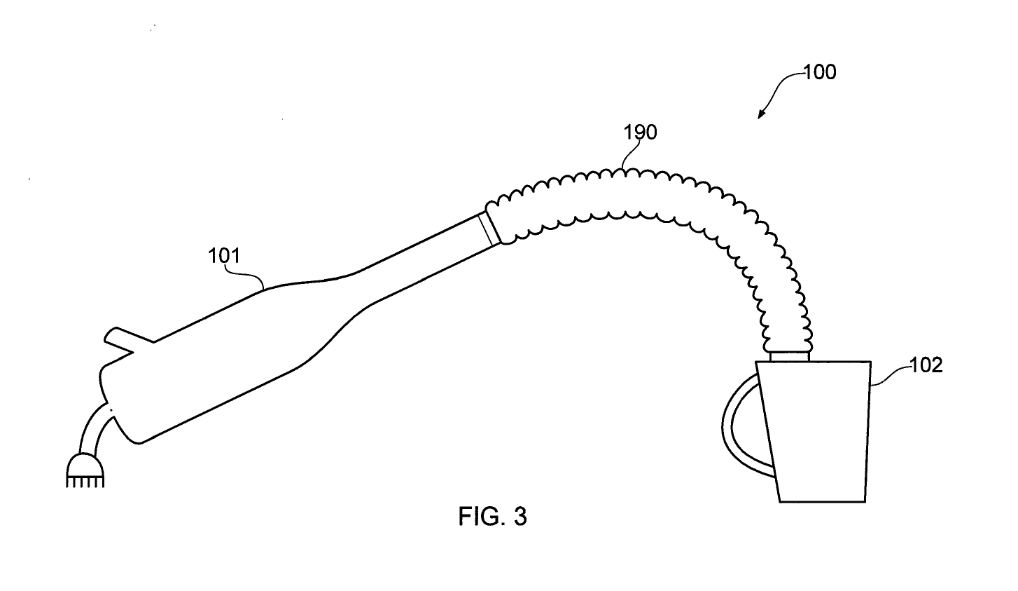

FIG. 1 shows a lance member 101 of cleaning apparatus 100 according to an embodiment of the present invention shown in FIG. 3. The lance member 101 has a substantially cylindrical, hollow casing 101C. The casing 101C has a body portion 101B and a handle portion 101H axially displaced with respect to the body portion 101B, the handle portion being of a lower diameter than the body portion 101B. The casing 101C tapers in a substantially continuous manner between the body portion 101B and the handle portion 101H. Other arrangements are also useful. In some embodiments the casing is not tapered between the body and handle portions 101B, 101H, but instead the diameter reduces substantially abruptly from the body portion 101B to the handle portion 101H. The casing 101C may be formed from metal such as steel, aluminium or any other suitable metal. In addition or instead the casing 101C may be formed from a plastics material such as a high temperature plastics material. The casing 101C may in some embodiments be formed from a carbon fibre composite material to lend strength, low weight and temperature resistance.

The lance member 101 has a brush member 170 coupled to the body portion 101B by means of a support arm 172. The brush member 170 has a fluid outlet arranged to allow cleaning fluid to flow over bristles 170B thereof.

In some alternative embodiments the lance member 101 is arranged wherein cleaning fluid may be directed from a nozzle directly towards a surface to be cleaned and not directly on to bristles of the brush member 170.

The brush member 170 may be formed from any suitable material. In some embodiments the brush member 170 has bristles formed from steel, brass, nylon or any other suitable plastics material capable of withstanding passage of the heated cleaning fluid thereover.

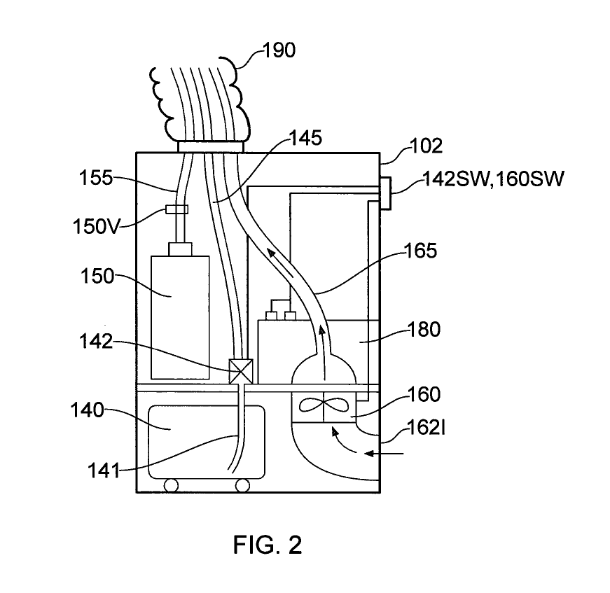

At an opposite end of the lance member 101 to the brush member 170, a free end of the handle portion 101H is operable to be connected to a hose member 190 (FIG. 2, FIG. 3) by means of which the lance member 101 may be coupled to a backpack module 102 as illustrated in FIG. 2 and discussed in further detail below.

A boiler 110 and associated burner 120 are provided within the body portion 101B. The boiler 110 has a hollow tubular member 111 mounted coaxially with and arranged to surround a burner pipe 125. The burner pipe 125 therefore passes through the tubular member 111, forming a double walled pipe region.

The burner pipe 125 and tubular member 111 define radially inner and radially outer walls of the boiler 110 between which cleaning fluid is contained. End cap plates 112 define substantially parallel, annular walls bridging a radial gap between the burner pipe 125 and tubular member 111. In an embodiment the tubular member 111 has a diameter of around 10 cm whilst the burner pipe 125 has a diameter of around 8 cm. Thus the radial gap between the burner pipe 125 and tubular member 111 is around 1 cm although other values are also useful. The boiler has a length of around 10 cm between end cap plates 112. Other sizes of boiler are also useful. It is to be understood that the relative diameters of the burner pipe 125 and tubular member 111 may be adjusted for a given burner size and flow rate of gas through the burner 120 to ensure that adequate heating of cleaning fluid may take place for a required flow rate of cleaning fluid through the boiler 110. It is to be understood that in normal use a continuous, substantially uninterrupted flow of cleaning fluid is typically established through the boiler at a rate sufficiently low to enable adequate heating of the cleaning fluid. The rate of flow of cleaning fluid through the boiler may be adjusted in some embodiments.

The portion of the burner pipe 125 running from one end cap plate 112 to the other may be considered to form part of the boiler 110. Optionally, substantially the whole burner pipe 125 may be considered to form part of the boiler 110.

The boiler 110 and burner 120 are formed from stainless steel in the embodiment shown although other materials are also useful.

The boiler 110 has a cleaning fluid inlet 110IN and a cleaning fluid outlet 110OUT. In the embodiment of FIG. 1 the inlet 110IN and outlet 110OUT are provided on diametrically opposite sides of the boiler 110 and are axially spaced apart. This feature forces fluid flowing through the boiler 110 to flow around at least half a circumference of the burner conduit 125 and along a portion of the boiler 110, increasing the amount of heat transferred to the cleaning fluid as it passes through the boiler 110 from the inlet 110IN to the outlet 110OUT. The cleaning fluid inlet 110IN is coupled to a cleaning fluid supply conduit 114 that extends through the handle portion 101H of the lance member 101 to a free end thereof. A connector (not shown) is provided at the free end of the lance member 101 for connecting the cleaning fluid supply conduit 114 to a corresponding conduit cleaning fluid supply conduit that passes along the hose member 190, within the hose member 190.

The burner 120 is mounted coaxially with the burner pipe 125 and is arranged to direct a flame generated by the burner 120 and associated combustion gases into the burner pipe 125 in a direction towards the boiler 110. The combustion gases therefore pass through the boiler 110 and warm the burner pipe 125. This results in heating of cleaning fluid within the boiler 110. The combustion gases continue along the burner pipe 125 to a free end thereof which is arranged to exhaust the combustion gases to atmosphere through an exhaust outlet 125E.

The burner 120 is supplied with fuel in the form of propane gas by means of a burner fuel supply conduit 127. The burner fuel supply conduit 127 and burner conduit 125 extend through the handle portion 101H of the lance member 101 to the free end thereof in a similar manner to the cleaning fluid supply conduit 114. The conduits 114, 125, 127 then couple to corresponding conduits passing through the hose member 190. In some alternative embodiments the members from which one or more of conduits 114, 125, 127 are fabricated are in the form of flexible tubing that extends in a substantially continuous manner through the hose member 190 to the back-pack module 102 without any joints being formed between lengths of tubing. The tubing may be formed from a rubber material, a plastics material or any other suitable material.

In the present embodiment the hose member 190 is not arranged to be routinely detached from and reattached to the lance member 101 except when required for servicing. The conduits 114, 125, 127 may therefore be fixedly coupled to corresponding conduits passing through the hose member 190. In some alternative embodiments one or more quick-release fixings may be provided to facilitate more regular i.e. more frequent attachment and detachment of the hose member 190 from the lance member 101.

The cleaning fluid outlet 110OUT of the boiler 110 is connected to brush member 170 by means of a brush cleaning fluid supply conduit 175. Heated cleaning fluid may thereby be fed to bristles 170B of the brush member 170 from the boiler 110. In some embodiments the heated cleaning fluid may be arranged to be fed to the bristles 170B in the form of hot vapour such as steam although in some embodiments the cleaning fluid may be arranged to be fed to the bristles 170B in a liquid phase as opposed to a vapour phase.

The back-pack module 102 (FIG. 2) contains a cleaning fluid storage reservoir 140, a fuel storage reservoir 150 and an air blower 160. A fluid pump 142 is operable to pump cleaning fluid from the cleaning fluid storage reservoir 140 by means of a pipe 141 and to pump the fluid into a cleaning fluid conduit 145 of the back-pack module 102. Conduit 145 passes via hose 190 to the lance member 101. The conduit 145 is provided in fluid communication with cleaning fluid supply conduit 114 of the lance member 101 via a connector thereby to supply cleaning fluid to the boiler 110.

The fuel storage reservoir 150 is coupled to a fuel supply conduit 155 of the back-pack module 102 which also passes through the hose 190 and is coupled to fuel supply conduit 127 of the lance member 101 via a connector. An isolation valve 150V is provided between the reservoir 150 and conduit 155 to enable isolation of the reservoir 150 from the conduit 155, for example when the apparatus is not in use or when it is required to replace the reservoir 150. The fuel storage reservoir may comprise multiple gas canisters coupled to the delivery conduit via a manifold. The manifold may advantageously allow gas to be drawn from another gas canister as the gas supply in an initial gas canister falls. The manifold may obviate the need to isolate each gas canister as they become empty during use. In the embodiment of FIGS. 1-3 the reservoir 150 is arranged to be in the form of an exchangeable canister although other arrangements are also useful.

The cleaning fluid storage reservoir 140 may also be arranged to be in the form of an exchangeable reservoir 140 that is replaced when spent.

The air blower 160 is arranged to draw air into the back-pack module 102 through an air inlet 1621 of the back-pack module 102 and to pump the air through an air supply conduit 165 which passes along the hose 190 to the lance member 101. The air supply conduit 165 is connected to the burner conduit 125 of the lance member 101 thereby to provide a flow of air therethrough.

The pump 142 and blower 160 are powered by means of a battery module 180. Respective on/off switches 142SW, 160SW are provided to switch the pump 142 and blower 160 on and off. In some embodiments one or both of the pump 142 and blower 160 may be arranged to be switched on or off automatically. In some embodiments the apparatus 100 may be arranged to allow gas to flow to the burner 120 only if the blower 160 is switched on. Thus in some embodiments the apparatus 100 may be operable to prevent a valve such as valve 150V from opening if the blower 160 is not switched on. Other arrangements are also useful.

In some embodiments the pump switch 142SW may be operable to vary a pumping speed of the pump 142 thereby to vary a flow rate of cleaning fluid through the boiler 110. The switch may include a rotary pump speed control or the like. The flow rate of cleaning fluid through the boiler 110 may alternatively be controlled by a variable valve member.

In some embodiments the blower switch 160SW may be operable to vary a pumping speed of the blower 160 thereby to vary a flow rate of air through the burner conduit 125. The switch may include a rotary pump speed control or the like. The flow rate of air through the burner conduit 125 may alternatively be controlled by a variable valve member.

In some embodiments the apparatus 100 may be arranged to detect whether the cleaning fluid storage reservoir 140 is empty. In the event the reservoir is empty, the apparatus 100 may be arranged to prevent the burner 120 from operating, for example by ensuring valve 150V or another suitable fuel control valve is closed.

The burner 120 has a thermocouple unit 120TC operable to open and close a fuel supply valve thereof. The unit 120TC is operable to prevent fuel from flowing into the burner from the fuel supply conduit 127 when a thermocouple element of the unit 120TC is below a critical temperature, indicating that the burner is not burning fuel. A user-operable thermocouple button 120TCSW is provided to allow the user to over-ride closure of the valve of the thermocouple unit 120TC when the burner 120 is lit and the thermocouple 120TC is cold, by pressing and holding the button 120TCSW. This enables the user to ignite the burner 120 and allow the thermocouple element time to warm above the critical temperature.

To assist the user in igniting the burner 120, a piezoelectric ignitor device 120PZ is provided. The device 120PZ is operable by means of a user-operable ignitor switch 120PZSW to generate a spark to ignite gas flowing from the burner 120. Other ignition arrangements may be useful including electronic ignition arrangements.

It is to be understood that expansion of gas within the fuel storage reservoir 150 upon passing out from the reservoir 150 to supply conduit 127 may result in cooling of the gas and as a consequence a wall of the reservoir 150. Accordingly, a heat source may be provided adjacent to the reservoir so that the reservoir may be prevented from falling to too low a temperature in use. The heat source may be heat generated by a fuel supply valve or other component part of the apparatus. For example, the heat source may be heat generated by a solenoid of a fuel supply valve that maintains the valve in an open condition when required.

To control the flame, a fuel pressure valve may be provided to regulate the pressure of the fuel supplied to the burner 120. For example, a fuel pressure valve may regulate gas pressure to 1 bar pressure or any other suitable pressure.

In some embodiments a battery state of charge (SoC) monitor is provided by means of which a user may check the SoC of the battery module 180. In some embodiments the user may press a switch in response to which a SoC meter indicates the amount of charge remaining in the battery module 180. Other arrangements are also useful.

In some embodiments, a counter such as a timer may be provided to count and optionally regulate the operational time of the apparatus. For example, a counter may be provided to count and optionally regulate the operational time of the air blower 160. The counter may be configured to count whenever an electrical circuit that provides power to the blower is closed.

In some arrangements, the cleaning fluid may be water. However if water is found to be inadequate for the task at hand, for example when seeking to remove stubborn deposits of gum or graffiti, a fluid (such as water) that includes a chemical cleaning agent may be employed.

It is to be understood that in some embodiments a blowback valve may be provided between the burner 120 and fuel storage reservoir 150 to prevent inadvertent ignition of fuel within the storage reservoir 150.

In some embodiments, a temperature sensor may be provided for measuring a temperature of a portion of the lance member 101 such as a portion of a casing of the lance member 101, a portion of the boiler 110 or any other suitable portion of the lance member 101. If the temperature sensor senses a temperature exceeding a critical value the apparatus 100 may be arranged to close a valve supplying gas to the burner 120 thereby to extinguish the burner 120 and prevent overheating of the apparatus 100. In some embodiments the apparatus 100 may sound an alarm instead of or in addition to closing a valve.

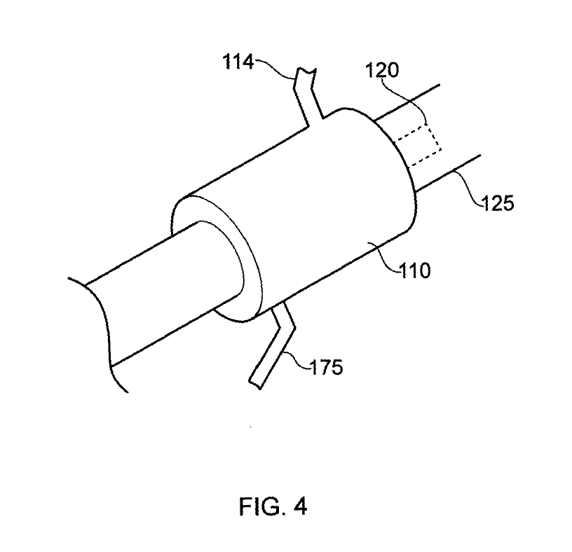

FIG. 4 is a perspective view of the boiler 110 showing the locations of the burner conduit 125 and burner 120.

In use, a user ensures that the back-pack module 102 is coupled to the lance 101 by means of the hose 190. The user ensures that an adequate supply of battery power is available, as well as fuel and cleaning fluid. The user may then switch on the blower 160 to establish a flow of air through the burner conduit 125 and open valve 150V to allow a flow of propane gas to the burner 120. The user then depresses thermocouple button 120TCSW to allow the gas to flow out from the burner 120 and depresses ignitor switch 120PZSW to ignite gas flowing out from the burner 120. Once the thermocouple element of the thermocouple unit 120TC has warmed to a sufficiently high temperature the user may release the thermocouple button 120TCSW and the burner 120 remains lit.

The user may then switch on cleaning fluid pump 142 to pump cleaning fluid through the boiler 110. It is to be understood that because the boiler 110 of the embodiment of FIG. 1 holds a relatively small amount of cleaning fluid, cleaning fluid within the boiler 110 warms relatively quickly and a flow of hot cleaning fluid to the brush member 170 is readily established.

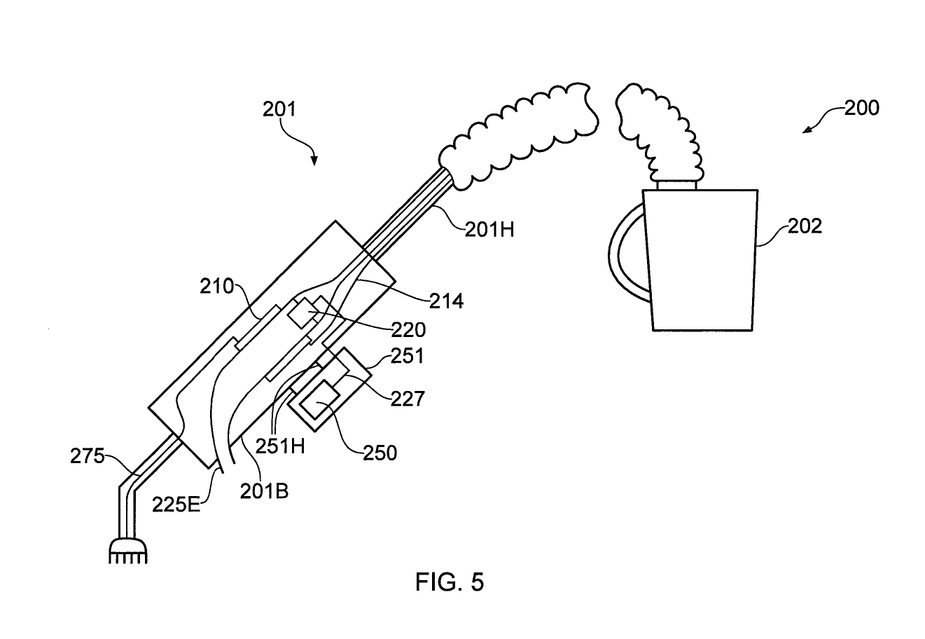

FIG. 5 shows a lance 201 according to a further embodiment of the invention. Like features of the embodiment of FIG. 5 to those of the embodiment of FIGS. 1 to 4 are shown with like reference signs incremented by 100.

In the embodiment of FIG. 5, the fuel storage reservoir 250 is arranged to be mounted to the lance member 101 instead of being provided in the back-pack module 102. The reservoir 250 is provided within a fuel pod 251 being a compartment that is coupled to the lance member 201 at an axial location thereof corresponding to the location of the burner 220 and boiler 210. The pod 251 is arranged in use to be warmed by heat emanating from the burner 220 and boiler 210 thereby to prevent the reservoir 250 from falling to an excessively low temperature. In the embodiment of FIG. 5 heated air is arranged to be blown into the pod 251 from the lance member 101 via a pair of hoses 251H provided between the lance member 101 and pod 251.

It is to be understood that expansion of gas within the reservoir 250 upon passing out from the reservoir 250 to supply conduit 227 may result in cooling of the gas and as a consequence a wall of the reservoir 250. Accordingly, by positioning the fuel pod 251 appropriately, the reservoir 250 may be prevented from falling to too low a temperature in use by heat generated by the apparatus 200.

In some embodiments the brush 160 may be replaced by another suitable implement or used in combination with another implement such as a scraper or the like.

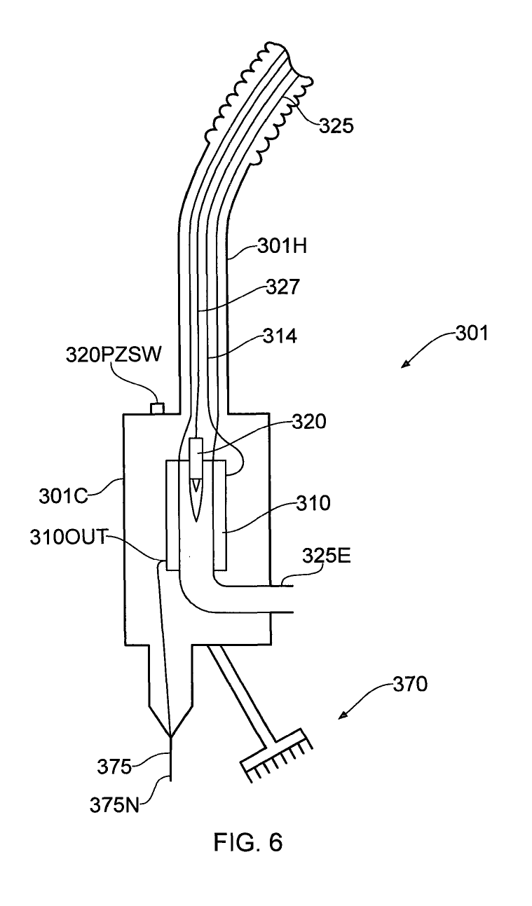

FIG. 6 shows a lance 301 according to a further embodiment of the invention. Like features of the embodiment of FIG. 6 to those of the embodiment of FIG. 5 are shown with like reference signs incremented by 100.

The lance 301 is of similar construction to the lance 101 of FIG. 1 except that the cleaning fluid outlet 310OUT of the boiler 310 is connected to a fluid supply conduit 375 that feeds heated fluid to an outlet nozzle 375N that is separate from brush member 370. The nozzle points in a direction parallel to (or in some embodiments substantially coincident with) a longitudinal axis of the lance 301. In use, a user may direct a flow of heated cleaning fluid, in some embodiments a flow of gaseous cleaning fluid, directly at the substance on the surface to be cleaned and then mechanically agitate the substance to remove it from the surface. Other methods of operation and other arrangements of the apparatus 301 are also useful. In some embodiments, the lance 301 may be configured to allow the brush member 370 to be provided with a flow of gaseous cleaning fluid in addition to the lance 301, optionally substantially simultaneously.

FIG. 7 shows a backpack module 302 according to an embodiment of the invention arranged to be coupled to a lance member according to an embodiment of the invention. The module has a casing 302C formed from a rigid plastics material such as ABS or the like. The module 302 has a lower compartment 302L and an upper compartment 302U separated by a panel 302P.

The upper compartment 302U houses a fuel gas canister 350 and a cleaning fluid storage reservoir 340.

The lower compartment 302L houses a battery 380, a fluid pump 342 and an air blower 360. The battery 380 is operable to provide electrical power to the pump 342 and blower 360 via a battery master switch 380SW. A battery level indicator lamp 380M is arranged to flash intermittently when the battery charge level falls below a preset value.

The fluid pump 342 is operable to pump cleaning fluid from the reservoir 340 through a fluid conduit 345. Conduit 345 passes via hose 390 to a lance member for heating.

The air blower 360 is arranged to draw air into the back-pack module 302 through an air inlet 3621 and to pump the air through an air supply conduit 365 which passes along the hose 390 to the lance member. The air supply conduit 365 is connected to the heater conduit of the lance member thereby to provide a flow of air therethrough.

The gas canister 350 is coupled to a delivery conduit 355 which also passes through the hose 390 and is coupled to fuel supply conduit of the lance member. An isolation valve 350V is provided between the reservoir 350 and conduit 355 to enable isolation of the reservoir 350 from the conduit 355, for example when the apparatus is not in use or when it is required to replace the reservoir 350. In the embodiment of FIG. 7 the isolation valve 350V may be opened and closed by means of a switch 350SW provided on an outer side of the casing 302C. The isolation valve 350V has a solenoid (not shown) that is actuated in the presence of electrical power, causing the isolation valve 350V to open and allow flow of fuel therethrough.

The module 302 is configured wherein the valve 350 may not be opened by means of the switch 350SW unless the air blower 360 is running. Accordingly, the air blower 360 is arranged to provide an output signal to the valve 350V via signal line 350S when the blower 360 is operating. If the output signal is not present, the valve 350V is arranged to close regardless of the state of switch 350SW.

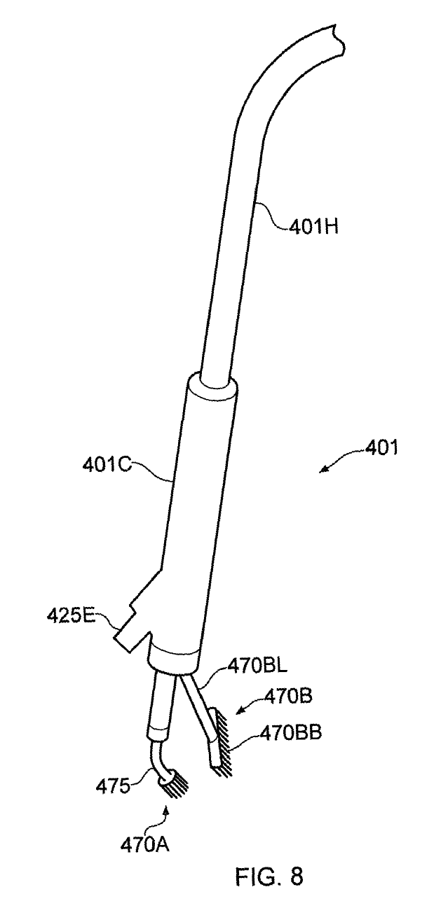

FIG. 8 shows a lance 401 according to a still further embodiment of the invention. Like features of the embodiment of FIG. 8 to those of the embodiment of FIG. 6 are shown with like reference numerals incremented by 100.

In the embodiment of FIG. 8, the cleaning fluid outlet of the boiler (not shown) is connected to a first brush member 470A by means of a brush cleaning fluid supply conduit 475. Thus heated cleaning fluid is supplied to the first brush member 470A. The first brush member 470A projects from a distal end of a casing 401C of the lance 401 in a direction substantially parallel to a longitudinal axis of the lance 401.

A second brush member 470B also projects from the distal end of casing 401C of the lance 401 but in a direction at an angle to the longitudinal axis of the lance 401. In the example shown the angle is around 45 degrees although other angles are also useful. The second brush member 470B has a leg portion 470BL that projects from the casing 401C and a brush portion 470BB arranged at right angles to the leg portion 470BL at an opposite end thereof, the leg and brush portions defining a substantially T-shaped brush member 470B. In the embodiment of FIG. 8 the leg portion 470BL of the brush member 470B is of adjustable length although other arrangements are also useful.

In use, the first brush member 470A may be used to soften and loosen gum that may have hardened on a surface using the heated cleaning fluid supplied thereto, the second brush member 470B being used to disperse debris. The second brush member 470B may be used to brush the debris into a collection receptacle in some arrangements.

In some embodiments the second brush member 470B may act as a support leg to support the lance 401 in an upright position, for example when an operator rests the lance 401 on ground temporarily. Other arrangements are also useful.

In some embodiments the second brush member 470B may be provided with a supply of heated cleaning fluid. For example in some embodiments the brush portion 470BB of the second brush member 470B may be provided with a supply of cleaning fluid. In some embodiments the first and second brush members 470A, 470B may be arranged to be provided with a supply of cleaning fluid to their respective brush portions 470AB, 470BB. In some embodiments only the second brush member 470B may be arranged to be provided with a supply of cleaning fluid.

In some embodiments the lance 401 may be operable to select whether one or both of the brush members 470A, 470B are provided with a supply of heated cleaning fluid. In some embodiments the lance 401 may be operable to provide one type of heated cleaning fluid to the first brush member 470A and a different type of heated cleaning fluid to the second brush member 470B. In some embodiments the lance 401 may be operable to provide non-heated fluid to one brush member, such as a non-heated chemical cleaning fluid. Other arrangements are also useful.

It is to be understood that embodiments of the invention may be employed to remove a range of unwanted substances from a given surface. For example, in some embodiments gum such as chewing gum may be removed from walkways by brushing in the presence of heated cleaning fluid. In some embodiments paint materials may be removed by brushing in the presence of heated cleaning fluid. Embodiments of the invention provide an economical solution to the problem of removal of unwanted substances at least in part due to portability of the apparatus in some embodiments. By heating only a relatively small amount of cleaning fluid at a given moment in time, a sufficient amount of cleaning fluid may be heated to a sufficiently high temperature for substance removal relatively quickly.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. Cleaning apparatus comprising:
an applicator portion having a fluid delivery outlet through which heated cleaning fluid may be dispensed;
a boiler through which a flow of cleaning fluid may be established from a fluid source to the fluid delivery outlet of the applicator portion; and
a heater portion,
the boiler comprising a heater conduit through which a flow of heated gases generated by the heater portion may be established to heat cleaning fluid in the boiler, the boiler comprising a pair of hollow tubes including an inner tube arranged to pass through at least a portion of an outer tube, the boiler being arranged such that cleaning fluid to be heated may be heated in a reservoir provided between the pair of hollow tubes, the inner tube defining at least a portion of the heater conduit.

2-3. (canceled)

4. The apparatus as claimed in claim 1, wherein the heater conduit is arranged to pass through at least a portion of the boiler such that in use cleaning fluid in the boiler may surround at least a portion of the heater conduit.

5. (canceled)

6. The apparatus as claimed in claim 1, wherein the heater portion is arranged to direct heated gas into the heater conduit.

7. The apparatus as claimed in claim 1, wherein the heater portion is provided substantially coaxial of the heater conduit.

8. The apparatus as claimed in claim 1, wherein the heater portion is provided at a location axially spaced apart from the heater conduit.

9. The apparatus as claimed in claim 1, wherein the heater portion is provided at a location immediately adjacent to or within at least a portion of the heater conduit.

10. The apparatus as claimed in claim 1, wherein the heater conduit is operable to direct heated gases through an exhaust outlet of the apparatus.

11. The apparatus as claimed in claim 1, comprising a blower arranged to blow for blowing gas through the heater conduit and to blow ambient air through the heater conduit.

12. (canceled)

13. The apparatus as claimed in claim 11, wherein the blower is arranged to establish a flow of gas around the heater portion and through the heater conduit.

14. The apparatus as claimed in claim 1, wherein the applicator portion comprises the boiler and the heater portion.

15. The apparatus as claimed in claim 1, comprising a reservoir that stores cleaning fluid to be supplied to the boiler.

16. The apparatus as claimed in claim 1, wherein the heater portion comprises an electrical heating element or a fuel burner.

17-18. (canceled)

19. The apparatus as claimed in claim 15, wherein the applicator portion comprises the reservoir.

20. The apparatus as claimed in claim 15, wherein the reservoir is provided remote from the applicator portion in a module arranged to be worn by a user.

21. The apparatus as claimed in claim 1, wherein the heater portion comprises a fuel burner and the applicator portion comprises a reservoir configured to store fuel for the fuel burner, the applicator portion being configured such that heat from the burner and/or boiler warms the fuel storage reservoir.

22. (canceled)

23. The apparatus as claimed in 18, comprising a blower configured to blow gas through the heater conduit, wherein the fuel storage reservoir and the blower are is provided remote from the applicator portion in a module arranged to be carried by a user.

24. The apparatus as claimed in claim 11, wherein the blower is provided remote from the applicator portion in a back-pack module arranged to be carried by a user.

25. The apparatus as claimed in claim 1, wherein the applicator portion comprises a lance member arranged to be carried by a user.

26. A method comprising:
providing a cleaning apparatus having an applicator portion with a fluid delivery outlet through which heated cleaning fluid may be dispensed;
establishing a flow of cleaning fluid from a fluid source to the fluid delivery outlet through a boiler;
generating heated gases via a heater portion; and
establishing a flow of the heated gases through a heater conduit of the boiler to heat cleaning fluid in the boiler,
wherein the flow of cleaning fluid passes through a reservoir provided between a pair of hollow tubes of the boiler, wherein an inner tube of the pair passes through an outer tube of the pair, the inner tube defining at least a portion of the heater conduit.

27-31. (canceled)

32. Cleaning apparatus, comprising:
an applicator portion having a fluid delivery outlet through which heated cleaning fluid may be dispensed;
a boiler through which a flow of cleaning fluid may be established from a fluid source to the fluid delivery outlet of the applicator portion;
a heater portion configured to heat the boiler and thereby heat the cleaning fluid;
a heater conduit in thermal communication with the boiler through which a flow of heated gases generated by the heater portion may be established to heat cleaning fluid in the boiler; and
a blower configured to blow ambient air through the heater conduit.
